(19) United States
(12) Patent Application Publication
(10) Pub. No.: US 2024/0153019 A1
(43) Pub. Date: May 9, 2024

(54) OTT PLATFORM FOR REAL ESTATE

(71) Applicants: Darshan Sedani, Cerritos, CA (US); Teodros Gessesse, Leesburg, VA (US); Devang Ajmera, Gujarat (IN); Joy Shah, Gujarat (IN); Jason LaVardera, Ridgefield, CT (US); Joshua LaVardera, Ridgefield, CT (US); Thomas LaVardera, Ridgefield, CT (US); Mike Sturges, Ridgefield, CT (US); Rajkumar Ramakrishnan, Gujarat (IN); Priyanka Gajjar, Gujarat (IN); Vaidehi Smart, Gujarat (IN)

(72) Inventors: Darshan Sedani, Cerritos, CA (US); Teodros Gessesse, Leesburg, VA (US); Devang Ajmera, Gujarat (IN); Joy Shah, Gujarat (IN); Jason LaVardera, Ridgefield, CT (US); Joshua LaVardera, Ridgefield, CT (US); Thomas LaVardera, Ridgefield, CT (US); Mike Sturges, Ridgefield, CT (US); Rajkumar Ramakrishnan, Gujarat (IN); Priyanka Gajjar, Gujarat (IN); Vaidehi Smart, Gujarat (IN)

(21) Appl. No.: 17/980,148

(22) Filed: Nov. 3, 2022

(51) Int. Cl. G06Q 50/16; G06Q 30/06; G06T 19/00

(52) U.S. Cl. CPC G06Q 50/16; G06Q 30/0643; G06T 19/003

(57) ABSTRACT

OTT Platform for Real Estate (OPRE) is an over-the-top (OTT) immersive media platform used to enhance real estate market participants' experience and to motivate real estate purchase decisions. OPRE is comprising combinations of hardware and software which can operate on various media delivery systems including iOS, Android, macOS, Windows OS, Roku, and TVOS (Apple TV). OPRE is also supported on Samsung and LG smart TVs. OPRE creates an enhanced interactive and immersive audio-visual environment. Users can view and interact with OPRE through a virtual reality (VR) headset to access the platform and view an environment that is presented in such a way as to enables the user to suspend disbelief and accept the presented environment and its contents as a credible environment.

### CROSS-REFERENCE TO RELATED APPLICATIONS

This application is related to Synchronized Media Experience System Through Similar or Dissimilar End-User Devices, application Ser. No. ______; Docket No. 2685.1002; filed Nov. 3, 2022; in the U.S. Patent and Trademark Office, the disclosure of which is incorporated herein in its entirety.

This application includes material that is subject to copyright protection.

### FIELD

OTT Platform for Real Estate (OPRE) is an invention in the field of over-the-top (OTT) immersive media content management and presentation for use in real estate listing, real estate properties display, virtual property management, content management, informational communications, visualization systems, and virtual reality presentation system software for use by real property buyers, property dealers, and property agents. The field includes self-detection of live, linear, and replicated OTT streams of information in OTT networks.

### DESCRIPTION OF RELATED ART

The world of digital delivery of multimedia content to viewers has been rapidly progressing. Typical types of multimedia content include video clips, immersive 360-degree video clips, 3-D stitched images, electronic games, and interactive content. The delivery process for such multimedia content, particularly those transmitted in a form of video, may entail use of a variety of delivery standards, video quality levels, and other parameters.

It is important to provide customers with reliable tools to help them make faster and informed decisions.

Current market statistics suggest over 51 percent of potential property buyers look for properties online, driving the popularity of virtual reality (VR) and augmented reality (AR) tools. Accelerated by the COVID-19 pandemic, the AR/VR marketing has gripped real estate, helping customers to make informed decisions from the comfort of their homes.

AR and VR experiences in the real estate industry also evoke emotions. A house tour with a VR storyline experience reflects commercial connectivity, compound security, and a friendly community. With an immersive customer experience, the real estate industry can expect higher and faster return on investment.

Immersive technology has helped investors, so that in a matter of minutes, potential buyers or renters can virtually visit dozens of locations and decide which are worth visiting in person. Immersive technology also can provide access to listing details. Immersive technology, especially with AR-based applications, can also include a design virtualization system and interface for communicating with marketers.

### SUMMARY

OTT Platform for Real Estate (OPRE) is an over-the-top (OTT) immersive media platform for real estate listing. This real estate property listing platform tags every property listing with 12 different types of media assets, which may include immersive 360-degree videos, pictures, multiple drone footages, and text-based data. This platform is a device-agnostic, multi-screen viewing experience with machine-learning-powered content discovery. These media assets are rendered, optimized, and coded for multiple operating systems. OPRE is fully compatible and adaptive on iOS, Android, MacOS, Windows OS, Roku, TVOS (Apple TV). It is also supported on Samsung and LG smart TVs. The core concept is to allow users to virtually visit properties without having to physically visit the property location. This OTT platform provides a complete set of media assets like 360 walkthroughs, neighborhood drone footage, city footage, agent-guided tours videos, etc., with respect to each property. Users can put on a VR headset or access the platform on smartphones, desktops, popular set-top boxes like Apple TV, Roku, or smart TVs and can experience immersive, three-dimensional walkthroughs of properties. In a matter of minutes, potential buyers or renters can efficiently visit dozens of locations and decide which are worth visiting in person.

The benefits and applications of virtual reality (VR) possess much potential and their application in real estate listing have heretofore not seen much development.

The realtor makes fewer trips to a subject property. In order to capably market a property, a realtor has to be very familiar with it. Thus, to know all the details, they often make a handful of trips to the location to add to their notes and refresh their memory. When the person has to juggle a dozen such properties, such physical trips take a significant toll of time and fuel. Fortunately, a digital model of the house can reduce the number of trips needed and allow the specialist to virtually “return” to the property.

Window shopping is known as the practice of checking out goods and products for purchase at a distance. VR can create the same effect in a simulation, giving prospective home-buyers the chance to visit and evaluate a building from afar. This is highly convenient for several reasons. Firstly, there is no pressure from the side of the agent and the customer can explore at their convenience. Secondly, they do not need to drive a long distance to get a tour, which eliminates the disappointment of investing time and money on a physical visit, only for the house to prove unsuitable for their needs. All a customer needs is access to the simulation and the right hardware.

Although creating a simulation of this type does require some investment, the costs are recuperated with the savings resulting from its application. Firstly, fuel costs are reduced both for agents and prospective customers, as they can visit the property remotely, so in-person visits become something reserved for only the most serious clients. Secondly, real estate services hardly need to invest in other marketing and promotional materials when they can just provide access to this convenient resource. Finally, giving tour access to realtors saves their time and allows them to accomplish more during their workday.

There are few technologies as immersive as VR, which can digitally put you in the shoes of a person walking around a building/home. The realism, familiar physics, and interactive elements all contribute to a highly immersive experience, which can help people form an emotional connection with a place. For example, if a prospective buyer or buyers goes inside the home and falls in love with the woodwork and designs, he/they will probably want to see and feel it in person. One can hardly get an effect like this by relying solely on a stand-alone video, photos, or other outdated promotional materials.

Unlike physical structures, simulated tours and walkthroughs can be customized with very little effort. From the side of the realtor, one can customize the tour to appeal to a certain category of customer. For example, one may want to focus on lighting, interior design and zoom features, and detail if the customer is a visual learner; or pop-up windows with detailed facts, statistics, and measurements for those who like to see the numbers. From the side of the client, one can easily add features for them to customize: furniture, changing the layout and coloring of a home, picking out possible interior design products they may want to buy, and much more.

### BRIEF DESCRIPTION OF THE DRAWINGS

FIG. 1 is a diagram illustrating the major system components and data flows among these system components in relationship to each other.

FIG. 2 illustrates the production sequence used to prepare video content, for inclusion in the system database, in preparation for viewing.

FIG. 3 illustrates more generally the data flows in the preparation of multiple types of informational content, in preparation for viewing.

FIG. 4 illustrates possible data flows involved in the use cases and user experience of the system.

### DETAILED DESCRIPTION

OPRE is an over-the-top (OTT) immersive media platform with an interactive immersive simulation program. This platform is device-agnostic, providing a multi-screen viewing experience with machine-learning-powered content discovery. The system's media assets hold content relevant to the subject real estate, real property, or other assets, which are rendered, optimized, and coded for multiple operating systems. This real estate property listing hardware and software system associates every property listing with 12 different types of media assets, including videos, pictures, and multiple drone footages. OPRE has a unique algorithm developed which allows users to watch 360-degree videos and 360-degree images using the apple TV's remote device as a track pad. It allows one to move around in 360-degree in videos and images. This unique algorithm overrides apple TV's functions enabling the system to utilize the device to its extended potentials.

OPRE operates as an advanced immersive artificial reality/virtual reality (AR/VR) software, with tools and sub-applications enabling guided 360-degree tours, allowing prospective clients a seamless customer experience. OPRE delivers a uniquely rich level of audio, video, and other types of multimedia content like the 360° video clips, 3d stitched images, interactive content and thorough immersive experience over the Internet in the context of a real estate platform. This represents an advance over other OTT platforms such as Hulu® or Netflix® for use in a real estate context.

OPRE is developed to be fully compatible and adaptive on different platforms like iOS, Android, macOS, Windows OS, Roku, TVOS (Apple TV). It also supported on Samsung and LG smart TVs.

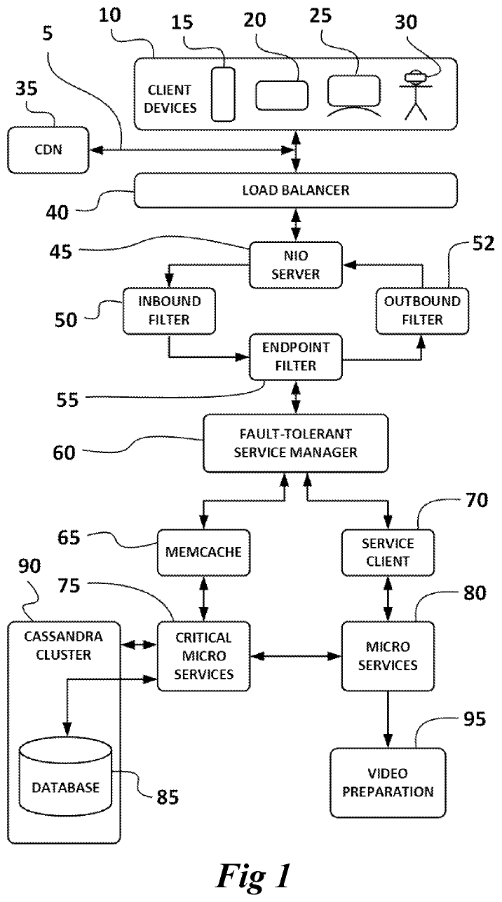

FIG. 1 is an illustration of the system architecture, comprising the components of the system, together with possible flows of the data through the physical components of the system. Possible data flows are shown as 5, typical of seventeen places as shown. OPRE is comprising three main groups of components. These groups are the client devices 10, a content delivery network 35 (CDN), and the so-called back-end, comprising elements 40 through 95. The client is the user interface on any device used to browse, play, and view videos and other content. User interface options comprise mobile devices 15, laptop computers 20, regular (desktop) computers 25, and wearable viewing devices 30.

A content delivery network 35 (CDN; in one embodiment a commercial product from the Amazon Web Services family of software products is used) is a system of distributed network servers that deliver pages and other Web content to a user, based on the geographic locations of the user, the origin of the webpage and the content delivery server.

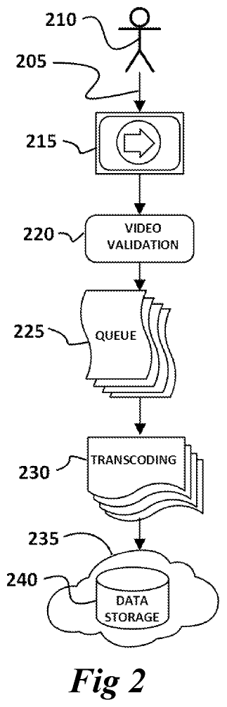

Before any OPRE content such as video content is made available to users, OPRE must convert the into a variety of formats, so the user can select a format that works best through the viewing device at hand. This process 95 is called transcoding or encoding, and further detail is provided at FIG. 2 below.

OPRE uses an Elastic Load Balancer 40 (ELB) service to route traffic to front-end services. ELB's are set up such that load is balanced across domain name services (DNS) zones first, then computer server instances. This is because the ELB is a two-tier load balancing scheme. The first tier consists of basic DNS-based round robin load balancing. This gets a client to an ELB endpoint in the cloud that is in one of the zones that the ELB is configured to use. The second tier of the ELB service is an array of load balancer instances (provisioned directly by the server hosting provider), which does round-robin load balancing over OPRE's own instances that are behind it in the same zone.

A non-blocking input/output (NIO) framework 45 (one embodiment implemented using the open-source product Netty) provides flexible data handling down on the socket level. NIO supports custom communication protocols between clients and servers. It supports SSL/TLS communication protocols, has both blocking and non-blocking unified application programming interfaces (APIs), and a flexible threading model. It's also fast and performant. The NIO works in conjunction with a set of data filters, namely an inbound filter 50, an outbound filter 52, and an endpoint filter 55. Handlers on the front and back of the filters are mainly responsible for handling the network protocol, web server, connection management and proxying work.

The inbound filter 50 runs before proxying the request and can be used for authentication, routing, or decorating the request. The endpoint filter 55 can either be used to return a static response or proxy the request to the backend service. The outbound filter 52 runs after a response has been returned and can be used for things like gzipping, metrics, or adding/removing custom headers. The outbound filter 52 supports HTTP2, mutual TLS, adaptive retries, and concurrency protection for the origin and also helps in easy routing based on query parameters, URL, and path specification. The main use case is for routing traffic to a specific test or staging server cluster within the OPRE system.

A latency and fault tolerance library 60 (in one embodiment the commercial product called Hystrix) is used to isolate points of access to remote systems, services and 3rd party libraries. which helps in stop cascading failures, real-time monitoring of configurations changes, concurrency aware request caching and automated batching through request collapsing. For example, if a microservice is failing then a default response is returned and the system waits until it recovers.

OPRE uses a so-called microservices architecture to power all of the APIs needed for its applications and Web apps. A service client 70 places API calls to microservices 80 for required data and the appropriate microservices respond as needed. Some services are identified as critical 75 so that they can works without many dependencies on other services. In case of cascaded service failures these critical microservices continue to operate.

One of the major design goals of the OPRE architecture's is stateless services. These services are designed such that any service instance can serve any request in a timely fashion and so if a server fails the system does undergo a massive failure. In the case of minor failure, case requests can be routed to another service instance and an alternative service node replaces the failed one.

When a node goes down all the cache goes down along with it and so the performance hit until all the data is cached. Memcache 65 is an in-memory key-value store for small chunks of arbitrary data (strings, objects) from results of database calls. Memcache can serve cached items in less than a millisecond, and enables the OPRE system to easily and cost effectively scale for high loads. Memcached is used for database query results caching, session caching, web page caching, API caching, and caching of objects such as images, files, and metadata. OPRE uses the commercial AWS product called Memcached to multiple copies of cache in shared nodes. When cache reads happens, they are taken from nearest cache or nodes, but when a node is not available, reads are taken from a different available node.

The system database 85 utilizes open source MySQL database(s). In one embodiment, the commercial AWS product EC2 MySQL is used, run by the commercial InnoDB database engine.

Cassandra 90 is a free and open-source distributed wide column store NoSQL database designed to handle large amounts of data across many commodity servers, providing high availability with no single point of failure. In OPRE, one or a plurality of MySQL databases are contained within a Cassandra cluster. A global Cassandra cluster can simultaneously service applications and asynchronously replicate data across multiple geographic locations. Cassandra can scale horizontally and dynamically by adding more servers as may be needed, without the need to reshard or reboot. Cassandra seeks to avoid vertical scalability limits and bottlenecks of any sort. There are no dedicated named nodes; instead all cluster nodes can serve interchangeably. Thus there are no practical limitations on data sizes, row/column counts, etc. This architecture enables OPRE to scale effectively to any size.

Referring to FIG. 2, video preparation is undertaken as materials are prepared for a data set pertaining to a specific property or real asset. Data flows are shown as arrows 205, typical five places.

Transcoding is the process that converts a video file from one format to another, to make videos viewable across different platforms and devices. OPRE supports different devices. Each device has a video format that looks best on that particular device. Through the onboarding process, OPRE creates files optimized for different network speeds.

A user 210 wishing to onboard a video into OPRE, first views the video on a conventional device 215, then sends the video through a validation step, 220. During this step, the system looks for digital artifacts, color changes, or missing frames that may have been caused by previous transcoding attempts or data transmission problems. The video is rejected if any problems are found. After the video is validated, it's fed into the media pipeline, beginning with a messaging queue 225. A pipeline such as this is simply a series of steps data is put through to make it ready for use, much like an assembly line in a factory.

It's not practical to process a single multi-terabyte sized file, so the first step of the pipeline is to break the video into lots of smaller chunks. The video chunks are then put through the pipeline so they can be encoded or transcoded 230 in parallel. In parallel simply means that multiple chunks are processed simultaneously in multiple computational threads.

OPRE creates files optimized for different network speeds. For example, a user watching a property video on a slow network might need to be sent a video that is played at low resolution. If the user is watching the same video on a high-speed network, the video might be in more appropriately transcoded into 4k resolution or 1080p resolution. Generally, the user may see grainy low resolution for some time on a slow network, while only poor or weak internet bandwidth is available. But if network conditions change to high speed, OPRE will suddenly switch the video to high-definition resolution. This kind of switching is called adaptive bitrate streaming.

In support of adaptive bitrate streaming, OPRE creates multiple copies of the same video in different resolutions, using parallel transcoding processes. The system may end up with as many as 1200 different files for the same video. All these different copies are pushed to every server in the CDN. Finally, when user loads the OPRE app next time on their mobile phone or smart TV or web app/desktop app, what happens is the application will figure out the best CDN server and the CDN will start streaming the video to the client/user. The client application will constantly check for the best CDN which is available near to the client's request location and switches dynamically based on the quality of bandwidth while the CDN is streaming the video.

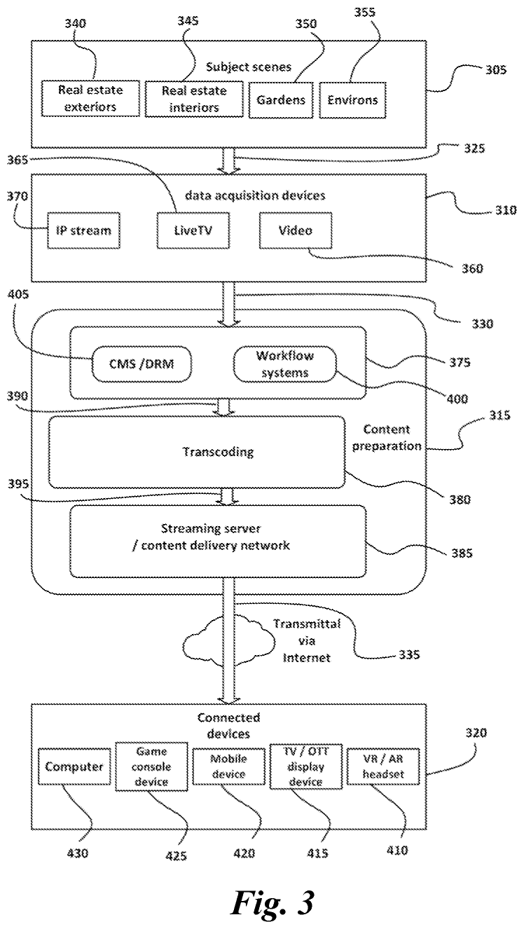

FIG. 3 illustrates the more general case of FIG. 2, where many kinds of content materials and assets are brought into the system in support of a specific real estate listing, real property listing or other asset listing. Data acquisition is broken generally into four major steps. Subject scenes 305 may be comprised of real estate exteriors 340, real estate interiors 345, gardens 350, and environs of all kinds 355. Data is passed 325 through data acquisition devices 310 which are comprising IP streams 370, live TV 365, and video 360. Acquired data is passed 330 to content preparation 315, flowing through a content management (CMS)/digital rights management (DRM) subsystem 405, and other workflow subsystems (400) which control and manage content preparation. Content is passed 390 to the transcoding step 380. As in the case of video as described in FIG. 2, multiple versions of transcoded information may be generated. Results are passed 395 to a streaming server 385 and stored in a content delivery network (CDN) for future use when a real estate or real property or other asset listing is examined by a system user. For such use, the information is transmitted via the Internet 335 to the user's connected device 320, such device from among a set comprising a computer 430, a game console device 425, a mobile device 420, a TV or OTT display device 415, or a virtual reality/augmented reality headset 410.

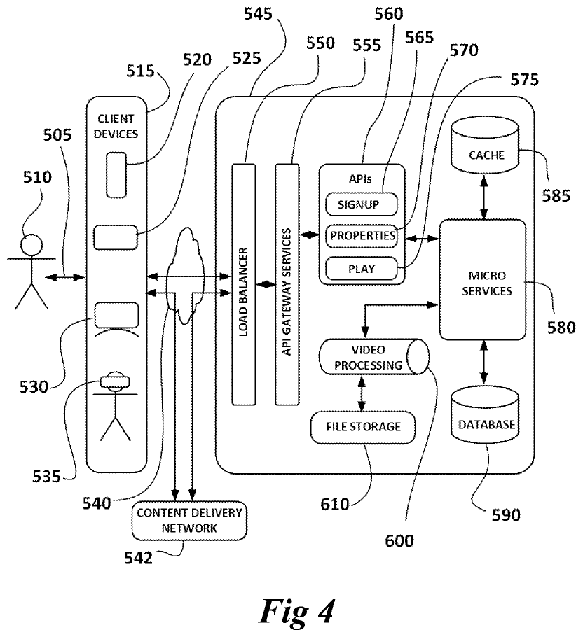

FIG. 4 illustrates use cases of the OPRE system. In this view, the system generally comprises a user 510, a set of clients device choices 515, an external content delivery network provided by an external commercial entity 542, and a so-called back-end set of computer servers, collectively represented as 545. The client devices 515 are comprising a mobile device 520, a laptop computer or tablet computer 525, a desktop computer 530, and a virtual reality headset 535. The back-end server set is comprising software including a load balancer 550, a set of API gateway services 555 that manage access to a set of APIs 560, including a user signup API 565, a properties API 570 through which real property data may be accessed, and a play API 575, through which a video play request can be handled. All such data traffic reaches a microservices subsystem 580 which provides varied actions depending on the nature of the request, cacheing data in a local cache 585, and drawing upon a set of databases 590. In the special case of preparation of video content, a video processing module 600 is called into action, storing its output temporarily in local file storage 610, before finally transferring such content to the external content delivery network 542. Data flows are generally represented as before with arrows 505, typical of eleven places in this illustration.

One example use case is a user 510 accessing the system 545 through a client device 515 to sign up for creation of an account. In this case data flows through the load balancer 550, the API services gateway 555, and the signup API 565 to the microservices section 580, where a suitably selected service presents an interactive process to the user 510 through the client device 515, and the user interactively completes and submits signup information which s ultimately stored in the database 590.

A second set of example use cases are described above with reference to FIGS. 2 and 3 above, where content materials are prepared for later viewing through the system, such content preparation following a similar route through the system as described here for the user signup, except that the selected microservices are different.

In a third example, a user wants to view content. In this case the user 510 sends a request through the client device 515, through the Internet 540, to the backend 545 which in turn sends a request to the content delivery network 542 to obtain content to send to the user 510. Based on the request type requested, (real estate exteriors, real estate interiors, gardens, or other environments or content assets) the data passes to and through several other components via various connections before the output reaches back to the requested user's client device 515.

The OPRE system is loosely coupled with various data driven components in subject scenes like the real estate exterior, real estate interior, garden, or environment which calls the data acquisition devices normal videos, (mentioned as ***), 360-degree videos (mentioned as ***), 3-D images (mentioned as ***), floor plans (mentioned as ***), brochures (mentioned as ***).

In one embodiment, OPRE uses Amazon Web Services (AWS) content delivery network (CDN) 542. Amazon's CDN stores OPRE's video content in various different locations throughout the world. When the user seeks to view a video stream from the CDN, the OPRE system automatically figures out the best CDN server, best format and best bitrate for viewing and then the video is streamed from a nearby CDN in AWS.

OPRE continuously records and analyzes user behavior including searches, viewing, location, types, reviews and other data using artificial intelligence (AI) and machine learning algorithms to better characterize each user, and stores this information in association with the user profile. Microservices can send events for tracking user activities or other data to the Stream Processing Pipeline for either real-time processing of personalized recommendation or batch processing of business intelligence tasks. Thus the system continuously learns and improves its ability to recommend new properties which a user might like.

The OPRE system provides an optimized, uninterrupted experience to the user without any obstruction while the user is watching a video or accessing other content.

OPRE is also powered with AI search which allows the system to provide the user with the best and most precise results in response to a search query. The OPRE search engine keeps on evolving and providing results based on individual's choice. It stores the keywords and generates a search algorithm around it. So whatever a user searches or types in, together with the user's video viewing pattern - - - all this information is saved and analyzed, enabling OPRE to not only better understand each individual user, but also to evolve better machine learning models using that data to understand the user choices better and to continuously improve its recommendation engine

OPRE supports both 3-degree-of-freedom systems (“3DoF”) and six-degree-of-freedom (“6DoF”) client viewing systems 535. 3DoF headsets allow tracking of rotational motion but not translational. As a user wears a VR headset, the system is tracking whether a user: 1) Looks left or right; or 2) Rotates their head up or down; or 3) Pivots left or right. OPRE supports commercial 3DoF headsets comprising the list: Google Cardboard, Oculus Go, Merge VR, Samsung Gear VR, and Google Daydream.

6DoF headsets allow tracking of translational motion as well as rotational motion. The system can determine whether a user has rotated their head and moved: 1) Forward or backward; or 2) Laterally or vertically; or 3) Up or down. OPRE supports 6DoF headsets comprising the list: Oculus Rift, Oculus Quest, HTC Vive, and Windows Mixed Reality.

OPRE also supports cross-wearable compatibility, comprising the list of devices: HTC Vive, HTC Vive Pro, Oculus Rift, Oculus Quest, PlayStation VR.O, Oculus Go, Lenovo Mirage Solo, Samsung Gear VR, Google Daydream View, Valve Index, Homido V2 Virtual Reality Headset, Zeiss VR and One Plus Virtual Reality Headset.

OPRE can provide an augmented reality layer in the context of a 6DoF application.

OPRE can also provide a second screen experience within the virtual reality display, projecting a second screen into the visual field of the headset 535.

In totality, the immersive audio-visual environment enables users to experience true interactive, immersive audio-visual reality in a variety of applications. The immersive audio-visual system comprises an immersive video system, an immersive audio system, and an immersive audio-visual production system. The video system creates immersive stereoscopic videos that mix live videos, computer-generated graphic images, and human interactions with the system. The immersive audio system creates immersive sounds with each sound resource positioned correctly with respect to the position of an associated participant in a video scene. The immersive audio-video production system produces enhanced immersive audio and videos based on the generated immersive stereoscopic videos and immersive sounds.

1. A system of an integrated virtual informational environment for improved user experience of viewing and evaluating real property, real estate, and other assets, the system comprising:
at least one processor; and
at least one memory to store instructions to cause the at least one processor to:
coordinate and control one or a plurality of server-based and user-facing modules of the system which operate on a cloud-based core software infrastructure;
manage software tools enabling administrative users of the system and other individuals using the system to load information into the system;
integrate one or a plurality of immersive viewing applications, providing integrated and functionally interoperating interactive computer displays, document overlays, streaming video, Webpage overlays, and over-the-top TV overlays appropriate for viewing and evaluation of real property, real estate, and other assets in a virtual environment;
enable development and posting of complex viewable information materials pertinent to the listing and sale of real property, real estate, and other assets by qualified individuals or entities;
store shared resources accessible to users of the system, said resources being viewable through display features of the system; and
control access to and sharing of stored data filtered by access criteria with administrators, realtors, real estate agents, or other system users setting or subject to such criteria.

2. The system of claim 1, where at least one processor is configured to provide one or a plurality of semantic search algorithms accessible to the user enabling searching for real estate properties, other real assets or other stored information listed in the system databases.

3. A software structure and operating means creating an immersive experience for users through one or a plurality of devices, comprising
a software structure as a framework for serving video content; and
a software structure as a framework for serving video content with Web content (HTML 5 and other formats) overlays and controls applicable to the Web content overlays; and
a software structure as a framework for serving video content, interactive content, and control signals in an immersive audio-visual system running in Unity and Virtual Reality user device displays; and
one or a plurality of software apps operating on or through one or a plurality of devices local to the user serving immersive content, said software apps operating within the unique operating systems of said remote devices,
where content is stored is multiple formats enabling network-optimized selection of format for presentation to the user, by means of continuous testing of network conditions and matching content format to maximize presentation quality given the detected network conditions.

4. The system of claim 1, with software comprising:
a virtual content preparation environment for preparing, arranging, editing, validating, transcoding and storing video, graphical images, and textual information pertinent to real estate, real property, and other assets; and
a virtual listing preparation environment for indexing data contents pertinent to real estate, real property, and other assets, making said data contents searchable.

5. The method of viewing content housed in the system databases of claim 1 in a virtual three-dimensional pathway through a projected three-dimensional model space, simulating the action of walking through said three-dimensional space represented by said data, such that
the action of viewing may be conducted through a virtual-reality headset, or
the action of viewing may be conducted through the screen of a conventional computer, or
the action of viewing may be conducted through the screen of a mobile device, and
the control of motion of the simulated action of walking through the model space is by means of a collateral pointing device or means conventionally associated with the viewing device.
